(19) United States
(12) Patent Application Publication
(10) Pub. No.: US 2002/0143814 A1
(43) Pub. Date: Oct. 3, 2002

(54) Systems and methods for automatic insertion of machine-readable graphical codes into printable documents

(75) Inventors: Paul J. Hepworth, Riverton, UT (US); Andrew Olsen, West Valley City, UT (US); Weiyang Zhou, Sandy, UT (US)

Correspondence Address: MADSON & METCALF, GATEWAY TOWER WEST, SUITE 900, 15 WEST SOUTH TEMPLE, SALT LAKE CITY, UT, 84101

(73) Assignee: The Code Corporation, Draper, UT

(21) Appl. No.: 10/103,038

(22) Filed: Mar. 21, 2002

Related U.S. Application Data
(60) Provisional application No. 60/279,353, filed on Mar. 27, 2001.

(51) Int. Cl. G06F 15/00

(52) U.S. Cl. 707/512

(57) ABSTRACT

A system is disclosed for enhancing a material with machine-readable graphical codes. The system includes a processor and memory in electronic communication with the processor. The memory includes a material that comprises an item. The memory also includes a material enhancing module. The material enhancing module obtains the material and identifies the item in the material. A machine-readable graphical code is then generated that corresponds to the item. The material enhancing module inserts the machine-readable graphical code corresponding to the item into the material.

### RELATED APPLICATIONS

This application is related to and claims priority from U.S. patent application Ser. No. 60/279,353 filed Mar. 27, 2001, for “System for Automatic Insertion of Machine-Readable Graphical Codes into Printable Documents,” with inventors Paul Hepworth, Andy Olsen and Weiyang Zhou, which is incorporated herein by reference.

### BACKGROUND OF THE INVENTION

1. Field of the Invention

The present invention relates generally to the field of graphical-code reading computer systems. More specifically, the present invention relates to a system and method for automatically inserting machine-readable graphical codes into printable documents.

2. Description of Related Background Art

Computer technology has made large amounts of information readily available. Electronic information sources are typically found on storage media or storage devices such as hard drives, CD-ROMs, DVD-ROMs, etc., on a local computer, on a local computer network or a global computer network, such as the Internet. The World Wide Web (“Web”) portion of the Internet is used by many to search for and access information.

Before a user can access relevant electronic information, he or she usually needs to enter some input before helpful information becomes available. By way of example, many computer users, when looking for particular information, will use the Web to find information. Typically users will begin their search for information by using a search engine on the Web. To perform a search, a user first enters one or more search terms. Typically, a user will then browse the results by clicking on various links and reading through the information found. After some manual browsing, the user often finds the relevant information. Finding and accessing electronic information from a CD-ROM or from a hard drive is similar in that some manual searching and browsing of data is required.

Once a user has certain electronic information, the user will often save the information so that it is accessible at a later time without having to search again for the information. For example, web sites are often saved electronically through a web browser into a bookmarks or favorites file, email addresses are typically saved in electronic address books, part numbers are sometimes stored in spreadsheets saved in an electronic file, etc.

As shown, data that identifies the electronic information is typically saved in electronic form. Thus, if the user has access to an electronic device, the user may store the data and later access the data. However, in various situations a user may wish to retain the data identifying the electronic information in a non-electronic form. For example, it may be beneficial to the user if the user could print material that would include the data identifying the electronic information. It would be beneficial if means were provided to enable printable materials to include data that would identify electronic information. Further, it would be beneficial if the data in the printable materials facilitated automatically accessing electronic information from the printed documents.

### BRIEF DESCRIPTION OF THE DRAWINGS

Non-exhaustive embodiments of the invention are described with reference to the figures, in which:

FIG. 1 is a block diagram of an embodiment of a system for enhancing a material with machine-readable graphical codes;

FIG. 2 is a flow diagram of a method for enhancing a material with machine-readable graphical codes;

FIG. 3 is an illustration of part of a web page with hyperlinks;

FIG. 4 is an illustration of part of a web page with hyperlinks that has been enhanced with machine-readable graphical codes;

FIG. 5 is a block diagram including a web page enhancing module used to enhance a web page with machine-readable graphical codes;

FIG. 6 is a flow diagram illustrating a method for inserting machine-readable codes into a web page;

FIG. 7 is a flow diagram of another method for inserting machine-readable codes into a web page;

FIG. 8 is a flow diagram of another method for inserting machine-readable codes into a web page;

FIG. 9 is a flow diagram illustrating additional steps that may be performed with the methods of FIGS. 7 and 8;

FIG. 10 is a flow diagram illustrating steps that may be performed before a browser is sent a select-all message;

FIG. 11 is a block diagram of an embodiment of a material enhancing module for enhancing documents with machine-readable graphical codes;

FIG. 12 is a flow diagram of a method for using the document enhancing module to insert machine-readable graphical codes into a document;

FIG. 13 is a block diagram of an embodiment of a material enhancing module that uses an established interface provided by the operating system and/or publishing application to embed or link graphical code objects into a document;

FIG. 14 is a flow diagram of a method for using the embodiment shown in FIG. 13;

FIG. 15 is a flow diagram of a method for enabling the editing of previously inserted codes;

FIG. 16 is a block diagram of an embodiment for searching for and locating items in material to be enhanced with machine-readable graphical codes;

FIG. 17 is a flow diagram of a method to search for matching strings and enhance the document with machine-readable graphical codes;

FIG. 18 is a block diagram of an enhancing module that uses templates to generate machine-readable graphical codes; and

FIG. 19 is a block diagram of graphical code reading device used in combination with a computer.

### DETAILED DESCRIPTION

A system is disclosed for enhancing a material with machine-readable graphical codes. The system includes a processor and memory in electronic communication with the processor. The memory includes a material that comprises an item. The memory also includes a material enhancing module. The material enhancing module obtains the material and identifies the item in the material. A machine-readable graphical code is then generated that corresponds to the item. The material enhancing module inserts the machine-readable graphical code corresponding to the item into the material.

Different embodiments of the system may process different kinds of materials. The material may be an electronic file. The electronic file may be a text file and/or a document, and the item may be a string. Alternatively, the electronic file may be an HTML file, and the item may be a hyperlink. Other examples of possible items include a part number and an email address.

The material may include a number of items. For the circumstances where the material includes a number of items, the material enhancing module may generate a number of machine-readable graphical codes. The machine-readable graphical code(s) may be saved to a file. Various templates may be used to generate the machine-readable graphical codes.

The memory may also include an application for processing the material. Depending on the type of material being processed, different applications may be used. For example, the application may be a word processor, a web browser, a spreadsheet program, etc. In order to obtain the item, the system may detect the application and send it a copy message. The inserting of the machine-readable graphical code may be accomplished by sending an insert message to the application.

The material enhancing module may be configured as a document enhancing module or as a web page enhancing module. The document enhancing module may generate an object that comprises the machine-readable graphical code. The object may include object properties. In certain embodiments, the object may be edited through use of a user interface for editing the object.

The material enhancing module may also be configured as a searching and enhancing module. The searching and enhancing module may operate to search for a string that matches a search pattern.

One embodiment of the system may be used for enhancing a web page with machine-readable graphical codes. With this embodiment, the material may be one or more web pages and the items may be hyperlinks. With this embodiment of the system, the material enhancing module may be configured as a web page enhancing module. The web page enhancing module may operate to obtain a web page and identify the hyperlink in the web page. The module may then generate a machine-readable graphical code corresponding to the hyperlink and insert the machine-readable graphical code into the web page. The web page may include multiple hyperlinks for which multiple machine-readable graphical codes may be generated.

The web page enhancing module may operate to obtain an original URL from a web browser. The module may then save an enhanced web page and send a new URL to the web browser. The machine-readable graphical code may be inserted into the web page so that when it is printed the web page includes the machine-readable graphical code adjacent to the hyperlink.

A computer program is also disclosed for enhancing a printable material with machine-readable graphical codes. The computer program includes the material enhancing module, which may be configured for various implementations, such as, for enhancing text files, documents, web pages, spreadsheets, etc.

The computer program may be distributed to users through various means. For example, the program may be distributed on a computer-readable medium.

A method is also disclosed for enhancing a printable material with machine-readable graphical codes. The material is obtained, and the item in the material is identified. A machine-readable graphical code is then generated that corresponds to the item. Finally, the machine-readable graphical code that corresponds to the item is inserted into the material.

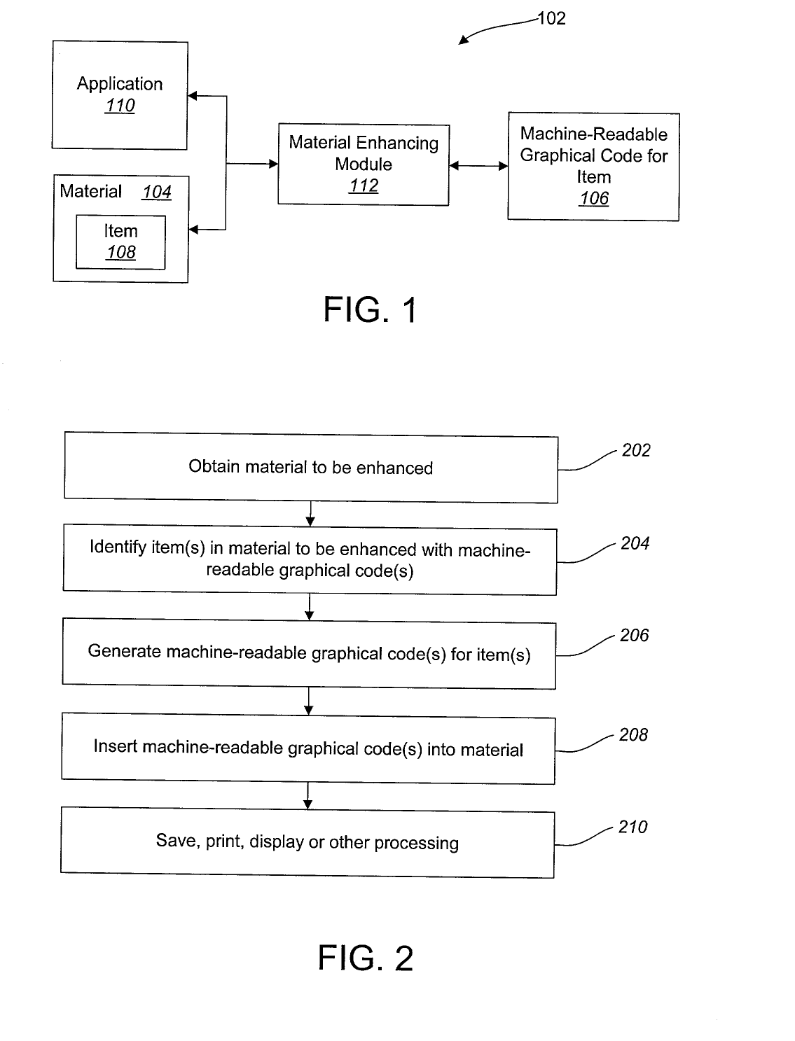

FIG. 1 illustrates a block diagram of an embodiment 102 for enhancing a material with machine-readable graphical codes. Material 104 comprises data to be enhanced with one or more machine-readable graphical codes 106. The material 104 is typically an electronic file. Examples of possible materials 104 are as follows: text files, HTML files, word-processing documents, publication documents, etc. However, the material 104 may not be electronic file. For example, the material 104 may simply be data stored in memory and being used and/or operated upon in memory.

The material 104 comprises one or more items 108 that are to be enhanced with one or more machine-readable graphical codes 106. The particular format of the item 108 depends on the type of material 104 being used. For example, if the material 104 were a text file or a word processing document, the item 108 may be a string. If the material 104 were an HTML file, the item 108 may be a URL. If the material 104 were a spreadsheet for inventories, the item 108 may be a part number. As illustrated, many different kinds of materials 104 and items 108 may be used with the embodiments herein.

In certain embodiments, an application 110 may be used to access and modify the material 104. The application 110 may be Microsoft Word if the material 104 were a word-processing document. If the material 104 were an HTML file, the application 110 may be Netscape Navigator. If the material 104 were a spreadsheet, the application 110 may be Microsoft Excel. Thus, as shown, many different applications 110 may be used with the embodiments herein.

The material enhancing module 112 is the program code that generally operates as discussed in relation to FIG. 2. The material enhancing module 112 may be of various forms developed with different means. By way of example, the material enhancing module 112 may be a library, an application, a plugin, a script, a macro, etc.

FIG. 2 is a flow diagram illustrating one possible method for enhancing a material with machine-readable graphical codes. Typically this method is implemented by the material enhancing module 112 or its equivalent. The module obtains 202 the material 104 to be enhanced with machine-readable graphical code(s) 106. Then the items 108 in the material 104 that are to be enhanced are identified 204. Machine-readable graphical codes 106 for the items 108 are then generated 206. The machine-readable graphical codes 106 are inserted 208 into the material 104. After the codes 106 are inserted, further processing 210 may take place. For example, the modified material may be saved, printed, displayed, etc.

Modifications may be made to the embodiment as described in FIGS. 1 and 2 to accomplish various tasks. The following descriptions illustrate exemplary embodiments for automatically inserting machine-readable graphical codes into materials.

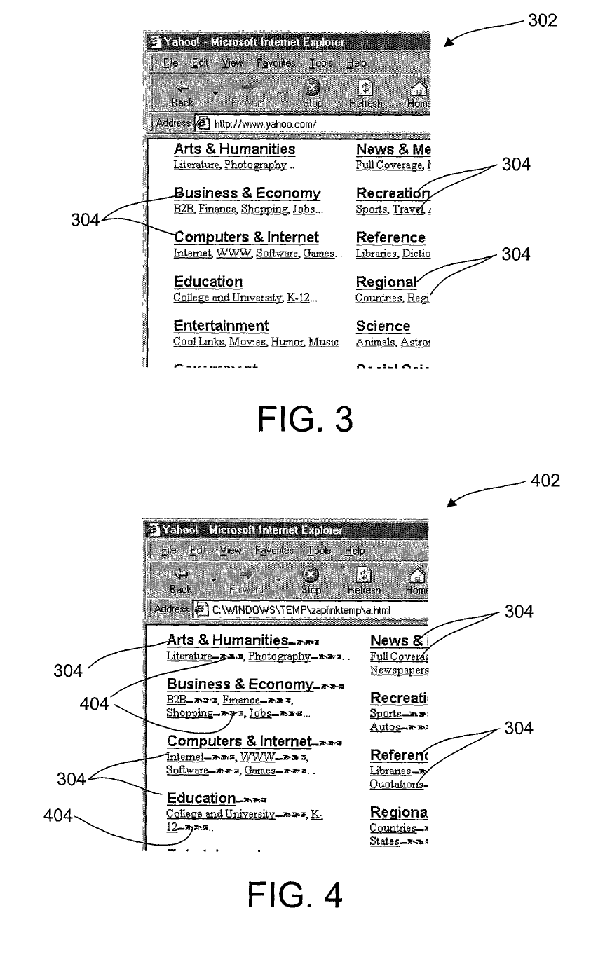

The embodiments of FIGS. 3-10 illustrate enhancing web pages by inserting machine-readable graphical codes for hyperlinks. Generally, this embodiment retrieves the HTML source of a web page, parses the source to find the hyperlinks, and generates and inserts a machine-readable graphical code for each. The embodiment is also capable of adding one special code for the URL of the original web page.

FIG. 3 illustrates a web page 302 before any machine-readable graphical codes 106 have been inserted in the web page 302. This embodiment of a material enhancing module 112 is used to retrieve the HTML source of the web page 302, depicted in FIG. 3, generate machine-readable graphical codes 106 and then insert the codes 106 into the HTML source to cause machine-readable graphical codes 106 to be displayed, as shown in FIG. 4.

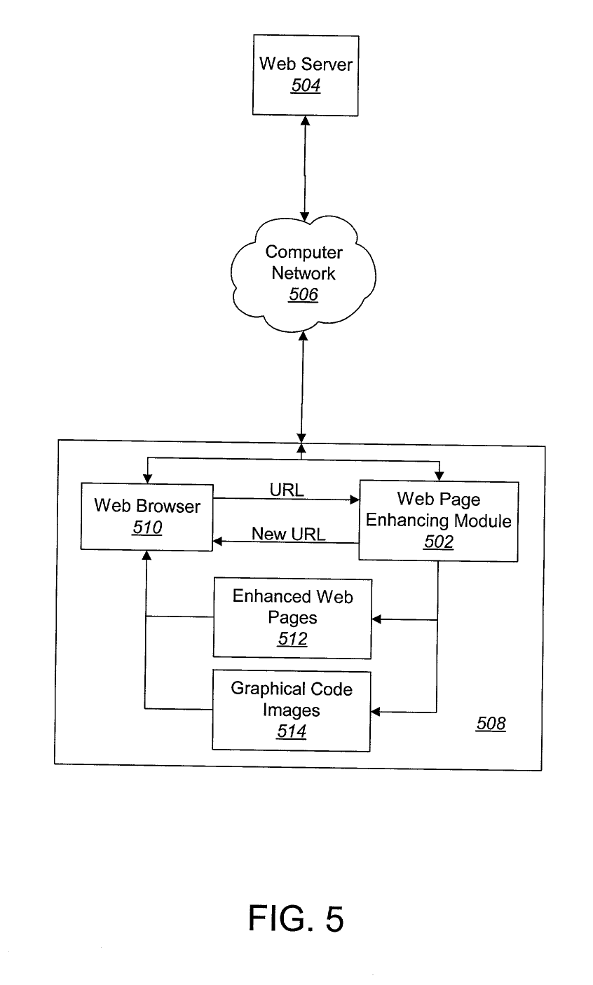

This embodiment of a material enhancing module 112 is used with material 104 comprising web pages 302 where the items 108 are hyperlinks 304. This particular embodiment of a material enhancing module 112 may be referred to as a web page enhancing module (shown in FIG. 5). The web page enhancing module operates to automatically add machine-readable graphical codes 106 to hyperlinks 304 which make it easier for a user to go back to the original web site and the original links in the web page when using a printout of the web page. As shown by FIGS. 3 and 4, the general layout of the web page 302 may be maintained. FIG. 3 illustrates the web page 302 before it has been enhanced with machine-readable graphical codes 106. FIG. 4 illustrates the web page 402 after it has been enhanced with the codes 404. The following description and related figures discuss with more specificity how the web page enhancing module may operate.

If a user prints the web page 402 that has been enhanced, he or she has access to the hyperlinks 304 (the actual addresses) through use of the graphical codes 404. Thus, the user may simply scan the machine-readable graphical codes 404 to discover the original hyperlinks 304. Scanning is typically easier for users to do to successfully obtain a URL than trying to manually type in a URL. In many situations users would not have access to the URL to type it in because web page printouts typically do not show the hyperlink URLs. In these situations, if the user wanted to obtain the URL, the user may first type in the URL of the parent page, then examine the parent page for the link, and finally the user may obtain the URL by clicking the link. The web page enhancing embodiment also makes it easier for a user to manually carry one or more hyperlinks with him/her by printing out the web page 402. As a result, printouts of web pages 402 are more useful because they include the hyperlink(s) 304. Thus, the web page enhancing embodiment may be used to link printed materials to resources on the Internet.

The embodiments illustrated in FIGS. 5-10 may be used to enhance a native browser's printing ability by adding machine-readable graphical codes 404 to the links 304 before printing. It is also possible to support enhancing a selected part of a page, rather than the entire page, using the browser's clipboard-copy support. Features of the embodiments disclosed herein may also be integrated into a browser's toolbar.

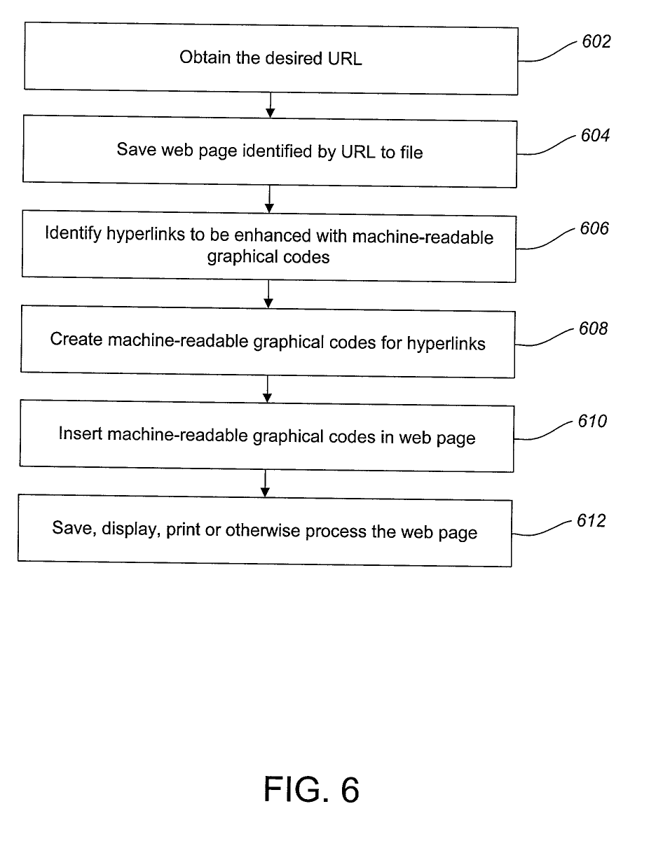

FIG. 5 illustrates a block diagram of a web page enhancing module 502 that may be used to enhance a web page 302 with machine-readable graphical codes 404. The flow diagrams of FIGS. 6-10 discuss various means by which the enhancing module 502 may operate. The block diagram in FIG. 5 illustrates that a web server 504 serves web pages 302 across a computer network 506 to one or more client computers 508. A web browser 510 may receive the web pages 302 and display them for the user. The web page enhancing module 502 may obtain the original URL and provide the browser with a new URL for the enhanced web page 512. As will be discussed below, the web page enhancing module 502 creates an enhanced web page 512 and machine-readable graphical codes 514 and stores them so that they are accessible by the web browser 510.

FIG. 6 is flow diagram illustrating a method for inserting machine-readable codes 404 into a web page 302. First, the enhancing module 502 obtains 602 the desired URL. The web page 302 identified by the URL is then saved 604. Then the web page 302 is examined and the module 502 identifies 606 hyperlinks 304 that are to be enhanced with machine-readable graphical codes 404.

Machine-readable graphical codes 404 for the hyperlinks 304 are created 608. Then the machine-readable graphical codes 404 are inserted 610 into the web page 302. The enhanced web page 402 may then be saved, printed and/or displayed 612.

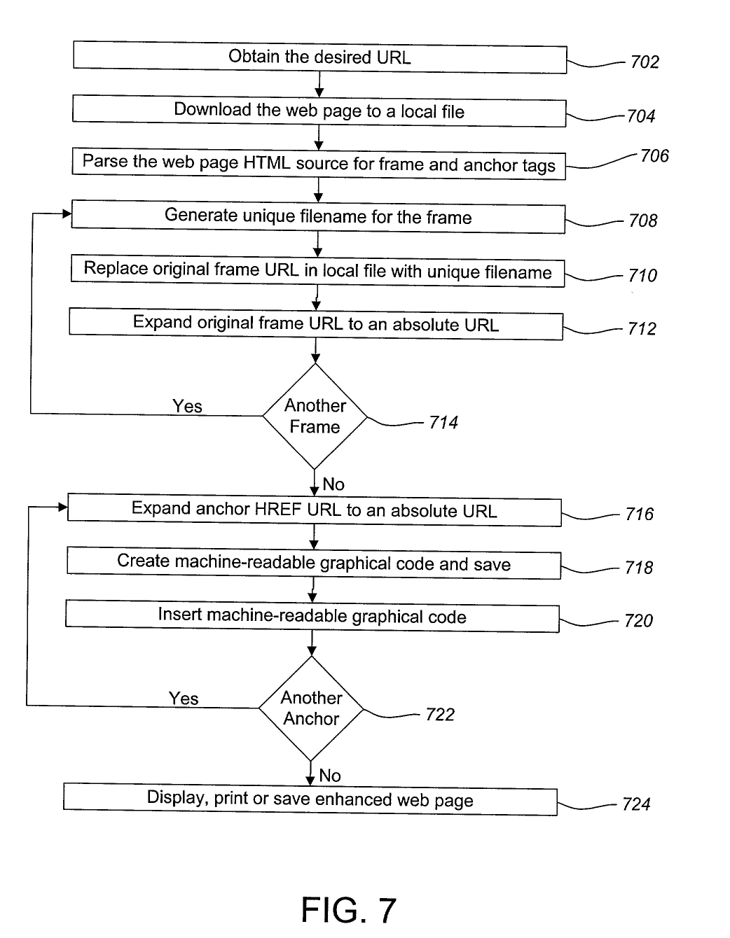

FIG. 7 is a flow diagram of another method for inserting machine-readable codes 404 into a web page 402. The operation of a web page enhancing module 502 may be initiated when a user clicks on a particular button, clicks on a button in the browser toolbar, double clicks an item, and the like. The module 502 obtains 702 the desired URL. In one possible embodiment, this step 702 may involve locating the topmost browser window and then using DDE or another available browser-supported interface to retrieve the current web page URL from the browser.

The web page 302 is then downloaded 704 to a local file. The HTTP protocol is typically used to download 704 the web page 302 to a local file. In one embodiment, the local file may be the source buffer. The module 502 parses 706 the downloaded web page html source for frame and anchor tags. For each frame, a unique filename is generated 708. Then the original frame URL in the source buffer is replaced 710 with the unique filename. The original frame URL is expanded 712 to an absolute URL. As shown in the flow diagram, if there is another frame to process 714, steps 708-712 are repeated.

For each anchor found in the parsing step 706, the following actions are performed. The anchor href URL is expanded 716 to an absolute URL. Then a machine-readable graphical code is created 718. Typically the machine-readable graphical code is saved in a graphics format (e.g., gif, jpeg, png) using a unique filename. Then the machine-readable graphical code is inserted 720 into the web page 402. The code may be inserted in a variety of ways. For example, in the source buffer, at the location just before the anchor end tag (</a>), an inline image tag may be inserted with the URL of the file generated. In this example, the module 502 may include in the image tag options to set the image size (for graphics formats which do not already include this information for the browser). If another anchor is available to process 722, steps 716-720 are performed.

Once the enhanced web page 402 is ready, it may be displayed, printed or saved 724. This may be done in various ways. For example, one skilled in the art may use DDE or other means (e.g. ShellExecute( )) to direct the browser to display or print the resulting enhanced web page 402 (complete with frames).

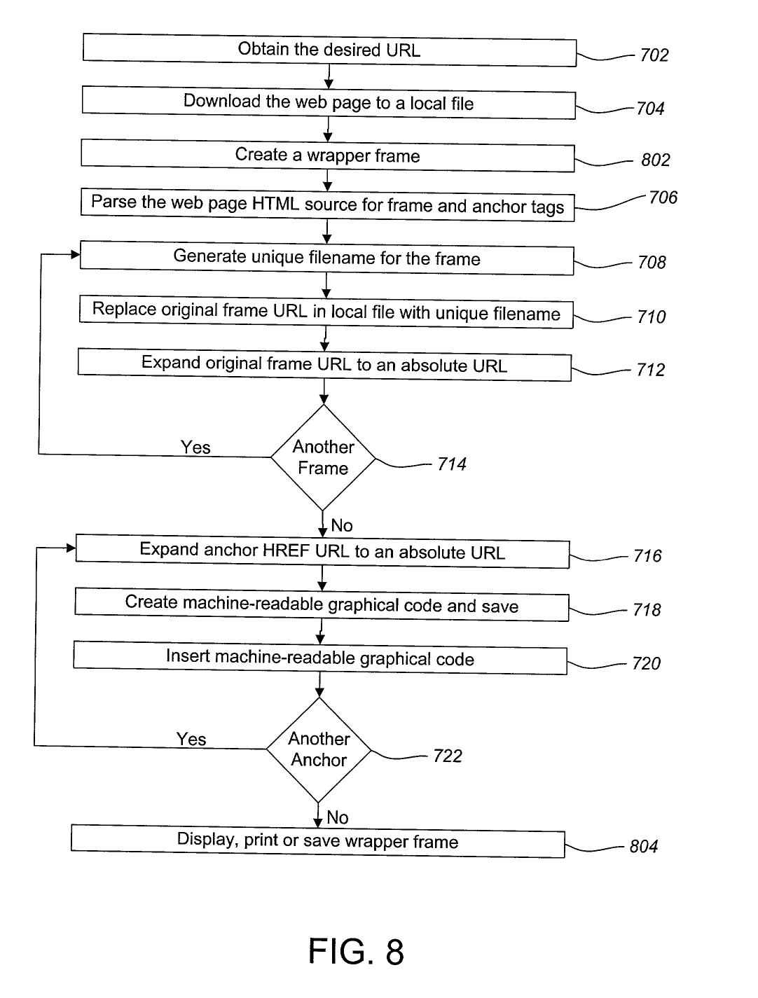

Those skilled in the art will appreciate that modifications may be made to the systems and methods disclosed herein without detracting from the scope of the inventive principles. For example, FIG. 8 is a flow diagram illustrating another method for inserting machine-readable codes into a web page. The embodiment of FIG. 8 is similar to the embodiment shown in FIG. 7. New steps that have been added are as follows. Before the parsing step 706, the module creates 802 a wrapper frame which contains a link for the original web page 302 (both the text URL and the appropriate machine readable graphical code) along with a child frame which contains the enhanced web page 402. Then, in the final step, the browser is directed 804 to the wrapper instead of to the enhanced web page 402.

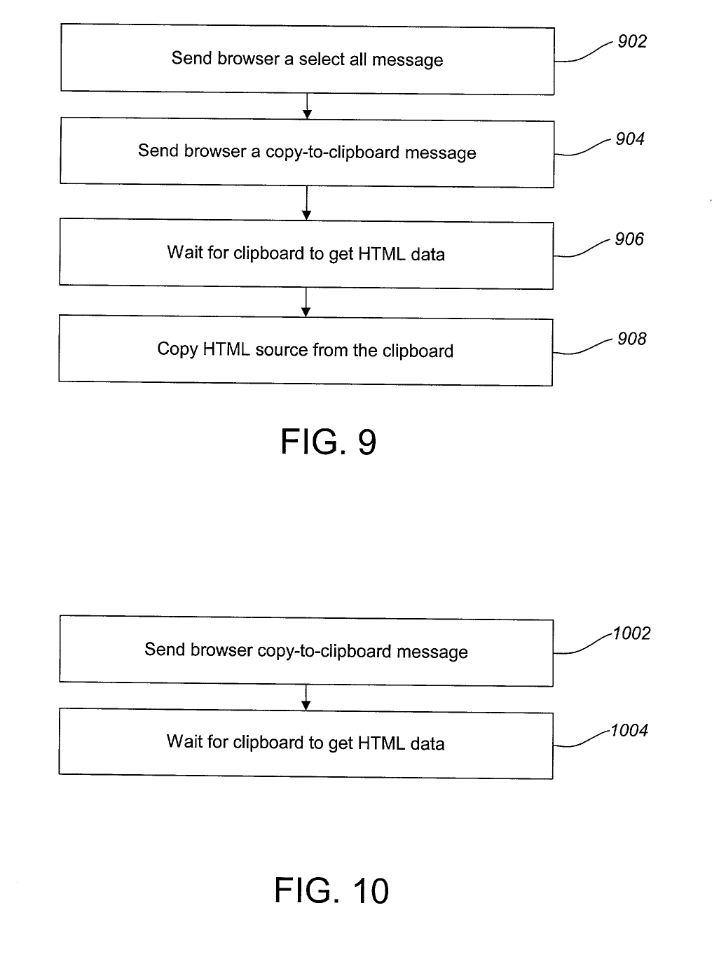

FIG. 9 illustrates additional changes that may be made to the method of FIG. 7. Instead of downloading 704 the web page to a local file, the module 502 may perform the following. The module 502 may send 902 the browser a select-all message. Then a copy-to-clipboard message may be sent 904 to the browser. The module 502 may wait 906 for the clipboard to obtain the HTML data (copied there by the browser). Finally, the HTML source is copied 908 from the clipboard. Typically the steps shown in FIG. 9 are performed more quickly than downloading the HTML source over the Internet because it uses the already-downloaded web page. The steps of FIG. 9 usually work with browsers that don't support the DDE “get-URL” functionality but do support clipboard (e.g., AOL 5 browser). The method of FIG. 9 also works with customized web pages that use the browser's cookies to tailor the web page.

Additional steps may also be performed with the flow diagram shown in FIG. 9. FIG. 10 illustrates additional steps that may be performed before the browser is sent 902 a select-all message. The browser may be sent 1002 a copy-to-clipboard message. Then the module 502 may wait 1004 for the clipboard to obtain the HTML data (copied there by the browser). Depending on how long it takes for the clipboard to obtain the HTML data, the module 502 may then proceed directly to copying 908 the HTML source from the clipboard, or it may proceed to sending 902 the browser a select-all message. The method illustrated by FIG. 10 allows a selected portion of the web page to be processed rather than the entire web page.

As stated, additional changes and modifications may be made to apparatus and methods disclosed herein. For example, the methods disclosed in FIGS. 6-10 may be integrated with a web-browser using internal interfaces.

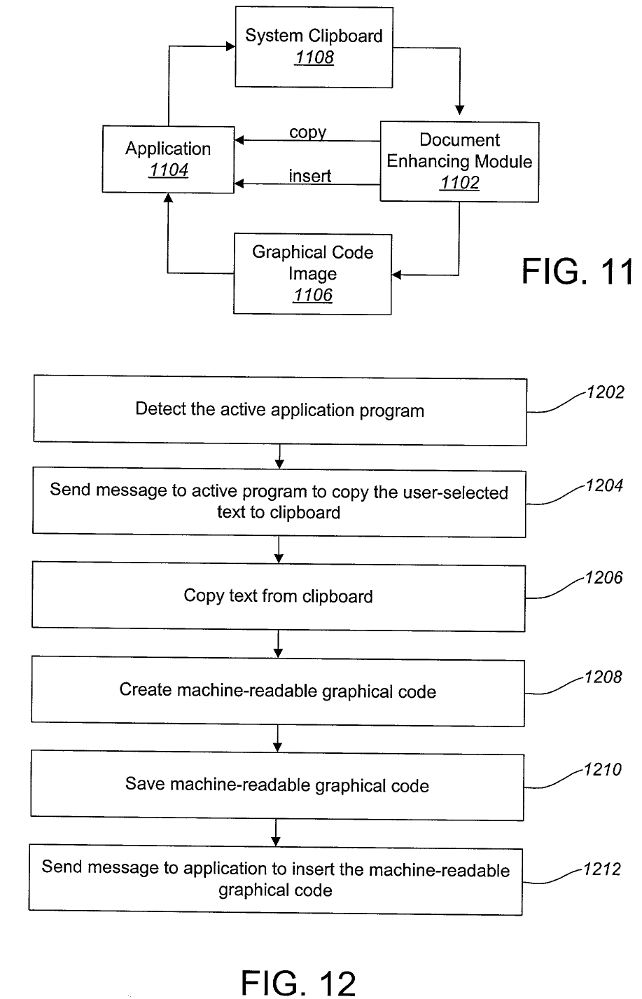

FIG. 11 illustrates an embodiment of a material enhancing module for enhancing documents with machine-readable graphical codes. A document enhancing module 1102 identifies the active application 1104 and sends appropriate messages (or keystrokes) to the application 1104 to copy the selected text. The document enhancing module 1102 creates a machine-readable graphical code image file 1106 for the selected text and sends the appropriate messages (or keystrokes) to the application 1104 to insert the machine-readable graphical code. The enhancing module 1102 uses the system clipboard 1108 and messages/keystrokes to automate code creation and insertion into a document. The enhancing module 1102 also recognizes the application program 1104 and sends appropriate messages specific to the application 1104.

FIG. 12 illustrates a method for using the document enhancing module 1102 to insert machine-readable graphical codes. The steps of the method may be initiated when a user activates the module 1102, which may be accomplished through a button, mouse click, command, and the like. The document enhancing module 1102 first detects 1202 the active application program 1104. The active application 1104 may be detected in various ways. For example, the module 1102 may obtain the title of the top-most window from the operating system (OS) (e.g., use GetForegroundWindow( ) and GetWindowText( )) and then look for a recognized application name as a substring in the window title (e.g., if title is “document1.doc—Microsoft Word,” application is Microsoft Word).

A message is sent 1204 to the active program 1104 to copy the user-selected text to the clipboard. In one embodiment, window messages or keystrokes may be sent to the active application 1104 to copy the user-selected (highlighted) text to the clipboard (e.g., for Microsoft Word, send Ctrl+C keystroke). The selected text is copied to the clipboard, and the enhancing module 1102 copies 1206 the text from the clipboard.

The document enhancing module 1102 creates 1208 a machine-readable graphical code containing the text copied from the clipboard and saves 1210 the code. The code may be saved as a file or it may be placed on the clipboard (application-specific). Finally, a message is sent 1212 to the application 1104 to insert the machine-readable graphical code into the document. In one embodiment, window messages or keystrokes may be sent to the application 1104 to insert the machine-readable graphical codes into the document and set its size and position. Depending on what particular application 1104 is being used to work with the document, various messages or keystrokes may be sent. For example, if Microsoft Word were being used, the enhancing module 1102 may send the following keystroke sequence: (a) alt+l (show Insert menu), (b) p (select picture), (c) f (select from file), (d) alt+n (set focus to filename: input field), (e) ctrl+v (paste the machine-readable graphical code image file location into the filename field), and (f) alt+s (hit the Insert button).

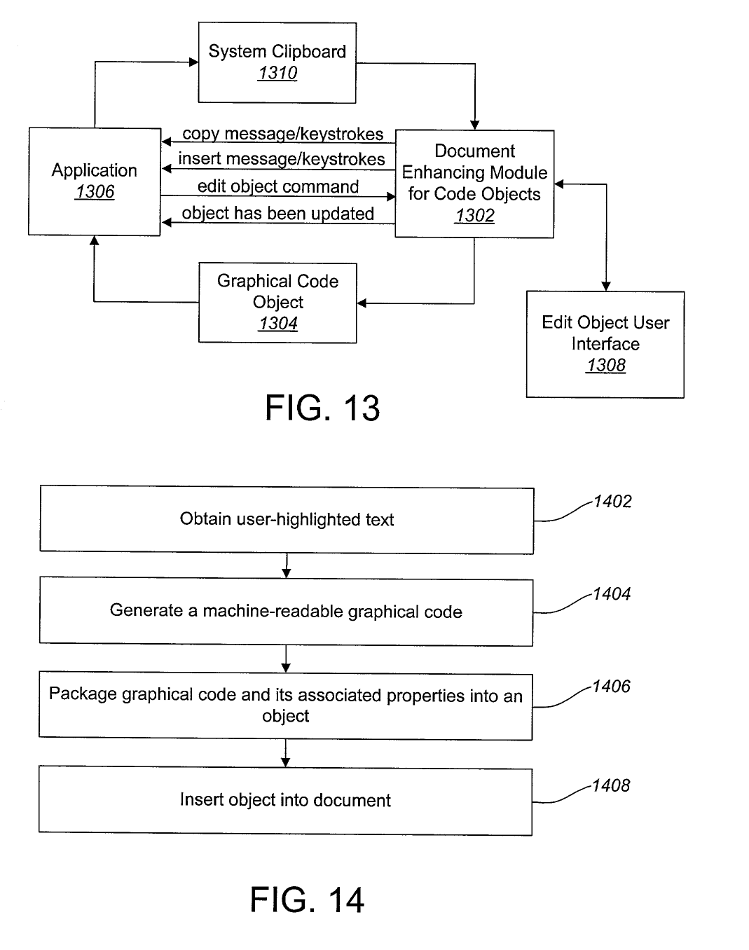

FIG. 13 illustrates another embodiment of a material enhancing module 112 that uses an established interface provided by the operating system and/or publishing application to embed or link graphical code objects into a document. A document enhancing module for graphical code objects 1302 is used to create an object 1304 that contains the machine-readable graphical code image and data associated with it. In operation, the object 1304 may be activated by the user from within the document to edit the contents of the graphical code 1304 and adjust its properties.

The document enhancing module 1302 may become an integrated module of multiple publishing applications 1306 through a software interface specific to the operating system and/or publishing application 1306 (e.g., Microsoft OLE or application extension module). Through this embodiment 1302, the machine-readable graphical code 1304 may be viewed and modified in a document while open with the application 1306, thus allowing editing and updating of codes in the document, instead of deleting and replacing the codes.

An edit object user interface 1308 may be used to edit the object. In the embodiment of FIG. 13, the application 1306 may send an edit object command to the document enhancing module 1302 to begin editing the object. Once the object has been edited, the document enhancing module 1302 may send a message to the application 1306 that the object has been updated. As with the embodiment of FIG. 11, the enhancing module 1302 may also send messages and keystrokes to the application 1306 to accomplish copying to the system clipboard 1310, inserting, etc.

FIG. 14 illustrates a method for using the embodiment shown in FIG. 13. The steps of the method may be initiated when a user activates the embodiment 1302, which may be accomplished through a button, mouse click, command, and the like. The user-selected text is copied or otherwise obtained 1402. This may be accomplished according to the method described in FIG. 12 or through another supported publishing software interface. Then a machine-readable graphical code based on the highlighted text is generated 1404. The document enhancing module 1302 packages 1406 the generated graphical code and its associated properties into an object (e.g., OLE object). Once the object has been packaged, it is inserted 1408 into the document. This may be accomplished according to the method described in FIG. 12 or through another supported publishing software interface.

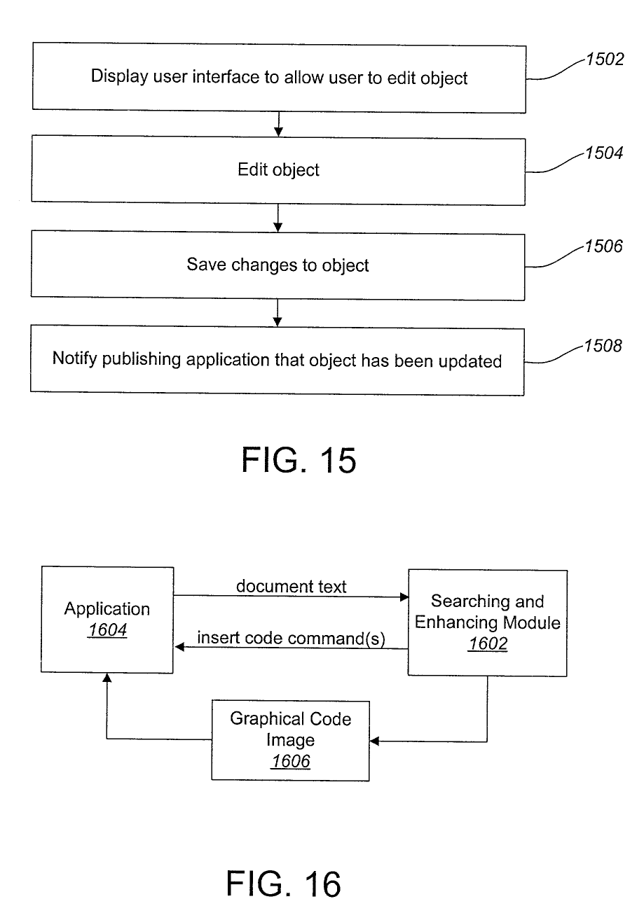

The enhancing module 1302 may also perform steps that enable the editing of previously inserted codes when the user activates the object from the publishing application 1306. FIG. 15 illustrates a flow diagram of a method that may be used to enable the editing of previously inserted codes. The enhancing module 1302 displays 1502 a user interface 1308 to allow the user to adjust the attributes and contents of the graphical code. The user may then edit 1504 the object. Once the user has made adjustments to the object, the module 1302 saves 1506 the changes and updates the graphical code image and associated attribute data in the object 1304. Using the supported application interface(s), the document enhancing module 1302 notifies 1508 the publishing application 1306 that the object 1304 has been updated using the supported application interface.

FIG. 16 is a block diagram of an embodiment for searching for and locating items in material to be enhanced with machine-readable graphical codes. A searching and enhancing module 1602 accesses a document through an interface specific to the application 1604.

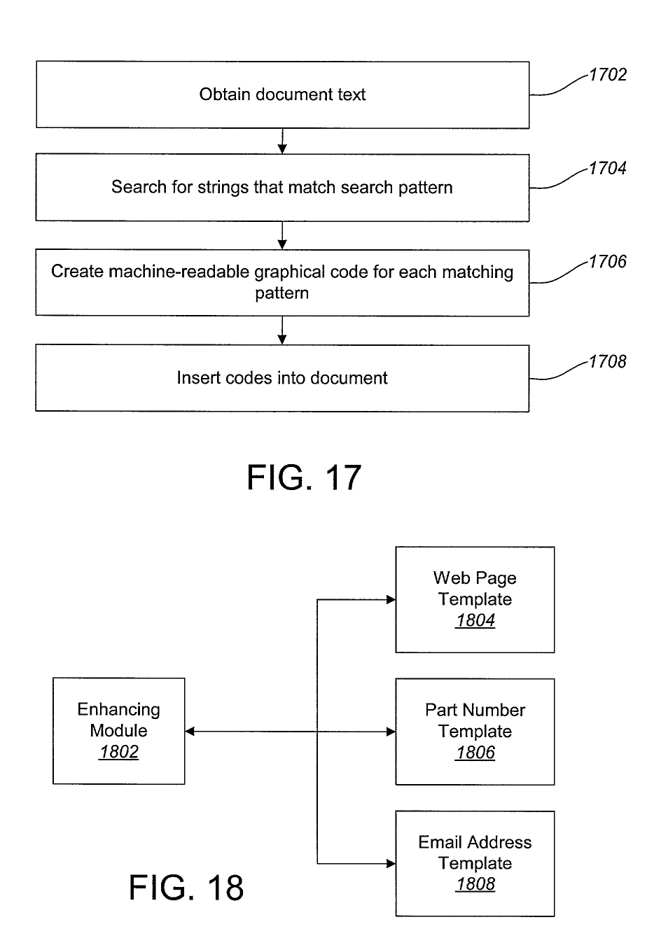

It will be appreciated by those skilled in the art that different kinds of materials may be searched through and enhanced with machine-readable graphical codes. One type of material that may be searched and enhanced is text. Other examples including graphics, commands, settings, etc. The exemplary embodiment of FIGS. 16-17 is discussed in relation to textual material. The searching/enhancing module 1602 may search text for URLs, e-mail addresses, and/or other user-specified patterns. When the searching/enhancing component finds a specified text pattern, it may generate a machine-readable graphical code 1606 and cause the publishing application 1604 to insert the graphical code 1606 according to the methods discussed above.

The searching/enhancing module 1602 may search for patterns in the text. For web-related searches, the searching/enhancing module 1602 may search for patterns such as the following: web:, http://, ftp://, www., ftp., .com or .edu. The searching/enhancing module 1602 may also search for email addresses patterns (e.g., [a-z0-9]@[a-z0-9]). In addition, the module 1602 may be configured to search for part numbers, phone numbers, etc. (e.g., [0-9][0-9][0-9]-[0-9][0-9]-[0-9][0-9][0-9][0-9] for a social security number).

The searching/enhancing embodiment 1602 may automate the generation of multiple machine-readable graphical codes 1606 and the insertion of them into a document. FIG. 17 illustrates a flow diagram of a method that may be used to search for matching strings and enhance the document with machine-readable graphical codes 1606. The searching/enhancing module 1602 obtains 1702 the document text through an application-specific interface. The document text is then searched 1704 for strings that match the selected search patterns. In one embodiment, the user configures the search patterns. Typically the searching/enhancing module 1602 provides a number of pre-configured search patterns. For example, pre-configured search patterns may include patterns for web-related documents, for email addresses, telephone numbers, etc.

Those skilled in the art will appreciate the various changes that may be made to searching algorithms and the various circumstances that may arise when searching for a string to enhance with a machine-readable graphical code. For example, for strings that match more than one search pattern, one skilled in the art may configure the searching/enhancing module 1602 to select the longest string that matches any of the patterns. In addition, the search may be for simple substring matches or for “regular expression” matches.

For each string found in the searching step 1704, the searching/enhancing embodiment 1602 may create 1706 a machine-readable graphical code image 1606 containing the string and insert 1708 the code into the document according to the methods discussed above. In one embodiment, the searching/enhancing module 1602 may also record into internal data structures information about all codes inserted into the document. Such information may be useful in tracking the document history and changes. For example, with this information a user may “undo” any document enhancements made. Using the record of the codes inserted, the module 1602 may then remove the codes from the document using an application-specific interface corresponding to the method by which the codes were inserted into the document.

The embodiments of material enhancing modules 112 disclosed herein generate machine-readable graphical codes. Different types of machine-readable graphical codes may be generated depending on the context of the code. To make the automatic creation of different types of machine-readable graphical codes easier, one or more graphical code templates may be used to generate graphical codes. The templates may be user-selectable and user-configurable templates that define the attributes of the generated code such as size, form-factor, bleed-correction, error-correction level, prefix data, suffix data, etc. As shown in FIG. 18, the enhancing module 1802 may use the appropriate template for the machine-readable graphical code. There may be a web page template 1804, a part number template 1806, an email address template 1808, etc. The enhancing module 1802 may allow the user to manually select a template, or they may use automatic template selection using pattern-matching rules.

For automatic template selection, each pattern may be associated with a template. For example, the pattern “www.” may be associated with the web page template 1804, while the pattern “pn[0-9]” may be associated with the part number template 1806, etc. If a particular pattern match is found, the corresponding machine-readable graphical code template may be used to generate the machine-readable graphical code. If there is no corresponding machine-readable graphical code template, a general template or default template (previously setup by the user) may be used.

The printable materials that may be enhanced with machine-readable graphical codes, as disclosed herein, may be scanned by a computer 1906 in electronic communication with a graphical code reading device 1902. The graphical code reading device 1902 may be used to scan the graphical code 1908 to obtain or provide the encoded data to the computer 1906. Various types of graphical codes 1908 may be used with systems and methods herein. For example, bar codes or matrix codes may be used as graphical codes 1908. Of course, any other graphical code 1908 that may be scanned may be used with embodiments herein.

The graphical code reading device 1902 may be connected to or integrated with the computer 1906. If graphical code reading device 1902 is connected to the computer 1906, the connection may be wireless or wired, or may be continuous or intermittent.

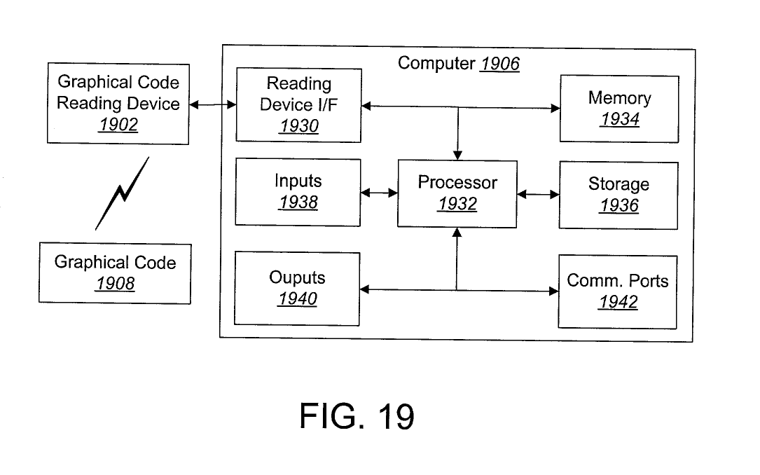

The computer 1906 shown in FIG. 19 may be a personal computer. Personal computers are commercially available and known by those skilled in the art. Components typically found in a computer 1906 will be discussed below.

FIG. 19 is a block diagram of hardware components that may be used in an embodiment of a computer 1906 used in combination with the graphical code reading device 1902. The computer 1906 is used in combination with the graphical code reading device 1902 to read in the graphical codes 1908 and to thereby access electronically-accessible data. The embodiment of the computer 1906 shown in FIG. 19 communicates with the graphical code reading device 1902 through the reading device interface 1930. The reading device interface 1930 may be a standard communications port typically found on a computer 1906, or it may be a specialized interface card provided along with the graphical code reading device 1902.

Many different types of computer systems may be used to implement the computer 1906 illustrated herein. The diagram of FIG. 19 illustrates typical components of a computer 1906 including a processor 1932, memory 1934, a storage device 1936, an input device 1938, and an output device 1940.

One or more communication ports 1942 may also be included in the computer 1906. It will be appreciated by those skilled in the art that more components may be included in the computer 1906. For example, several input devices 1938 may be included, such as a keyboard, a mouse, a joystick, a touch screen, etc. In addition, several output devices 1940 may be included such as a monitor, speakers, a printer, etc. Thus, those skilled in the art will appreciate that additional components may be added to the computer 1906 without detracting from the functionality to serve as a computer 1906.

The computer 1906 may be a conventional desktop computer. Desktop computers are commercially available. However, it will be appreciated by those skilled in the art that the computer 1906 is a broadly defined digital computer. A computer 1906, as used herein, is any device that includes a digital processor capable of receiving and processing data. A computer 1906 includes the broad range of digital computers including microcontrollers, hand-held computers, personal computers, servers, mainframes, supercomputers, and any variation or related device thereof. In current design, the computer 1906 is typically an IBM-compatible personal computer running the Linux or Microsoft Windows 95/98/2000 or NT operating system. Of course, other types of computers with different operating systems may be used. For example, an Apple computer or a UNIX workstation may be used as the computer 1906.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A system for enhancing a material with machine-readable graphical codes, the system comprising:
a processor;
memory in electronic communication with the processor, the memory comprising:
the material, wherein the material includes an item;
a material enhancing module programmed to implement a method comprising:
obtaining the material;
identifying the item in the material;
generating a machine-readable graphical code corresponding to the item; and
inserting the machine-readable graphical code into the material.

2. The system as defined in claim 1 wherein the material comprises an electronic file.

3. The system as defined in claim 2 wherein the electronic file is a text file.

4. The system as defined in claim 1 wherein the item is a string.

5. The system as defined in claim 2 wherein the electronic file is a document.

6. The system as defined in claim 2 wherein the electronic file is an HTML file.

7. The system as defined in claim 1 wherein the item is a hyperlink.

8. The system as defined in claim 1 wherein the item is a part number.

9. The system as defined in claim 1 wherein the item is an email address.

10. The system as defined in claim 1 wherein the material comprises a plurality of items and wherein the material enhancing module generates a plurality of machine-readable graphical codes.

11. The system as defined in claim 1 wherein the memory further comprises an application for processing the material.

12. The system as defined in claim 11 wherein application is a word processor.

13. The system as defined in claim 11 wherein the application is a web browser.

14. The system as defined in claim 1 wherein the material enhancing module comprises a document enhancing module.

15. The system as defined in claim 14 wherein the memory further comprises an application for processing the material.

16. The system as defined in claim 15 wherein the method further comprises detecting the application and sending a copy message to the application.

17. The system as defined in claim 15 wherein the method further comprises saving the machine-readable graphical code to a file.

18. The system as defined in claim 15 wherein the inserting is accomplished by sending an insert message to the application to insert the machine-readable graphical code from the file.

19. The system as defined in claim 15 wherein the document enhancing module generates an object that comprises the machine-readable graphical code.

20. The system as defined in claim 19 wherein the object further comprises object properties.

21. The system as defined in claim 19 wherein the method further comprises providing a user interface for editing the object.

22. The system as defined in claim 1 wherein the material enhancing module comprises a searching and enhancing module.

23. The system as defined in claim 22 wherein the method further comprises searching for a string that matches a search pattern.

24. The system as defined in claim 1 wherein the machine-readable graphical code is generated through use of a template.

25. The system as defined in claim 23 wherein the search pattern is associated with a template and the machine-readable graphical code is generated through the use of the template.

26. A system for enhancing a web page with machine-readable graphical codes, the system comprising:
a processor;
memory in electronic communication with the processor, the memory comprising:
the web page, wherein the web page includes a hyperlink;
a web page enhancing module programmed to implement a method comprising:
obtaining the web page;
identifying the hyperlink in the web page;
generating a machine-readable graphical code corresponding to the hyperlink; and
inserting the machine-readable graphical code into the web page.

27. The system as defined in claim 26 wherein the web page comprises a plurality of hyperlinks and wherein the web page enhancing module generates a plurality of machine-readable graphical codes.

28. The system as defined in claim 26 wherein the memory further comprises a web browser for processing the web page.

29. The system as defined in claim 26 wherein the method implemented by the web page enhancing module further comprises saving an enhanced web page.

30. The system as defined in claim 26 wherein the method implemented by the web page enhancing module further comprises obtaining an original URL from a web browser.

31. The system as defined in claim 29 wherein the method implemented by the web page enhancing module further comprises sending a new URL to a web browser.

32. The system as defined in claim 26 wherein the machine-readable graphical code is inserted into the web page so that when printed the web page includes the machine-readable graphical code adjacent to the hyperlink.

33. The system as defined in claim 28 wherein the method implemented by the web page enhancing module further comprises sending a copy-to-clipboard message to the web browser.

34. The system as defined in claim 26 wherein the machine-readable graphical code is generated through use of a template.

35. The system as defined in claim 33 wherein the method implemented by the web page enhancing module further comprises sending a select-all message to the web browser.

36. A computer program for enhancing a printable material with machine-readable graphical codes, the computer program comprising:
a material enhancing module programmed to implement a method comprising:
obtaining the material;
identifying an item in the material;
generating a machine-readable graphical code corresponding to the item; and
inserting the machine-readable graphical code into the material.

37. The computer program as defined in claim 36 wherein the material comprises an electronic file.

38. The computer program as defined in claim 37 wherein the electronic file is a text file.

39. The computer program as defined in claim 36 wherein the item is a string.

40. The computer program as defined in claim 37 wherein the electronic file is a document.

41. The computer program as defined in claim 37 wherein the electronic file is an HTML file.

42. The computer program as defined in claim 36 wherein the item is a hyperlink.

43. The computer program as defined in claim 36 wherein the item is a part number.

44. The computer program as defined in claim 36 wherein the item is an email address.

45. The computer program as defined in claim 36 wherein the material comprises a plurality of items and wherein the material enhancing module generates a plurality of machine-readable graphical codes.

46. The computer program as defined in claim 36 wherein the material enhancing module comprises a document enhancing module.

47. The computer program as defined in claim 36 wherein the method further comprises detecting an application for processing the material.

48. The computer program as defined in claim 47 wherein the method further comprises sending a copy message to the application.

49. The computer program as defined in claim 47 wherein the method further comprises saving the machine-readable graphical code to a file.

50. The computer program as defined in claim 47 wherein the inserting is accomplished by sending an insert message to the application to insert the machine-readable graphical code from the file.

51. The computer program as defined in claim 46 wherein the document enhancing module generates an object that comprises the machine-readable graphical code.

52. The computer program as defined in claim 51 wherein the object further comprises object properties.

53. The computer program as defined in claim 51 wherein the method further comprises providing a user interface for editing the object.

54. The computer program as defined in claim 36 wherein the material enhancing module comprises a searching and enhancing module.

55. The computer program as defined in claim 54 wherein the method further comprises searching for a string that matches a search pattern.

56. The computer program as defined in claim 36 wherein the machine-readable graphical code is generated through use of a template.

57. The computer program as defined in claim 55 wherein the search pattern is associated with a template and the machine-readable graphical code is generated through the use of the template.

58. A computer program for enhancing a web page with machine-readable graphical codes, the computer program comprising:
a web page enhancing module programmed to implement a method comprising:
obtaining the web page;
identifying a hyperlink in the web page;
generating a machine-readable graphical code corresponding to the hyperlink; and
inserting the machine-readable graphical code into the web page.

59. The computer program as defined in claim 58 wherein the web page comprises a plurality of hyperlinks and wherein the web page enhancing module generates a plurality of machine-readable graphical codes.

60. The computer program as defined in claim 58 wherein the method implemented by the web page enhancing module further comprises saving an enhanced web page.

61. The computer program as defined in claim 58 wherein the method implemented by the web page enhancing module further comprises obtaining an original URL from a web browser.

62. The computer program as defined in claim 60 wherein the method implemented by the web page enhancing module further comprises sending a new URL to a web browser.

63. The computer program as defined in claim 58 wherein the machine-readable graphical code is inserted into the web page so that when printed the web page includes the machine-readable graphical code adjacent to the hyperlink.

64. The computer program as defined in claim 58 wherein the method implemented by the web page enhancing module further comprises sending a copy-to-clipboard message to a web browser.

65. The computer program as defined in claim 58 wherein the machine-readable graphical code is generated through use of a template.

66. The computer program as defined in claim 64 wherein the method implemented by the web page enhancing module further comprises sending a select-all message to the web browser.

67. A computer-readable medium for storing program data, wherein the program data comprises executable instructions for implementing a method comprising:
obtaining a material;
identifying an item in the material;
generating a machine-readable graphical code corresponding to the item; and
inserting the machine-readable graphical code into the material.

68. The medium as defined in claim 67 wherein the material comprises an electronic file.

69. The medium as defined in claim 68 wherein the electronic file is a text file.

70. The medium as defined in claim 67 wherein the item is a string.

71. The medium as defined in claim 68 wherein the electronic file is a document.

72. The medium as defined in claim 68 wherein the electronic file is an HTML file.

73. The medium as defined in claim 67 wherein the item is a hyperlink.

74. The medium as defined in claim 67 wherein the item is a part number.

75. The medium as defined in claim 67 wherein the item is an email address.

76. The medium as defined in claim 67 wherein the material comprises a plurality of items and wherein the method further comprises generating a plurality of machine-readable graphical codes.

77. The medium as defined in claim 67 wherein the method further comprises detecting an application for processing the material.

78. The medium as defined in claim 77 wherein the method further comprises sending a copy message to the application.

79. The medium as defined in claim 77 wherein the method further comprises saving the machine-readable graphical code to a file.

80. The medium as defined in claim 77 wherein the inserting is accomplished by sending an insert message to the application to insert the machine-readable graphical code from the file.

81. The medium as defined in claim 67 wherein the method further comprises generating an object that comprises the machine-readable graphical code.

82. The medium as defined in claim 81 wherein the object further comprises object properties.

83. The medium as defined in claim 81 wherein the method further comprises providing a user interface for editing the object.

84. The medium as defined in claim 67 wherein the method further comprises searching for a string that matches a search pattern to identify the item.

85. The medium as defined in claim 67 wherein the machine-readable graphical code is generated through use of a template.

86. The medium as defined in claim 84 wherein the search pattern is associated with a template and the machine-readable graphical code is generated through the use of the template.

87. A computer-readable medium for storing program data, wherein the program data comprises executable instructions for implementing a method comprising:
obtaining a web page;
identifying a hyperlink in the web page;
generating a machine-readable graphical code corresponding to the hyperlink; and
inserting the machine-readable graphical code into the web page.

88. The medium as defined in claim 87 wherein the web page comprises a plurality of hyperlinks and wherein the method further comprises generating a plurality of machine-readable graphical codes.

89. The medium as defined in claim 87 wherein the method further comprises saving an enhanced web page.

90. The medium as defined in claim 87 wherein the method further comprises obtaining an original URL from a web browser.

91. The medium as defined in claim 89 wherein the method further comprises sending a new URL to a web browser.

92. The medium as defined in claim 87 wherein the machine-readable graphical code is inserted into the web page so that when printed the web page includes the machine-readable graphical code adjacent to the hyperlink.

93. The medium as defined in claim 87 wherein the method further comprises sending a copy-to-clipboard message to a web browser.

94. The medium as defined in claim 87 wherein the machine-readable graphical code is generated through use of a template.

95. The medium as defined in claim 93 wherein the method further comprises sending a select-all message to the web browser.

96. A method for enhancing a printable material with machine-readable graphical codes, the method comprising:
obtaining the material;
identifying an item in the material;
generating a machine-readable graphical code corresponding to the item; and
inserting the machine-readable graphical code into the material.

97. The method as defined in claim 96 wherein the material comprises an electronic file.

98. The method as defined in claim 97 wherein the electronic file is a text file.

99. The method as defined in claim 96 wherein the item is a string.

100. The method as defined in claim 97 wherein the electronic file is a document.

101. The method as defined in claim 97 wherein the electronic file is an HTML file.

102. The method as defined in claim 96 wherein the item is a hyperlink.

103. The method as defined in claim 96 wherein the item is a part number.

104. The method as defined in claim 96 wherein the item is an email address.

105. The method as defined in claim 96 wherein the material comprises a plurality of items and wherein the method further comprises generating a plurality of machine-readable graphical codes.

106. The method as defined in claim 96 further comprising detecting an application for processing the material.

107. The method as defined in claim 106 further comprising sending a copy message to the application.

108. The method as defined in claim 106 further comprising saving the machine-readable graphical code to a file.

109. The method as defined in claim 106 wherein the inserting is accomplished by sending an insert message to the application to insert the machine-readable graphical code from the file.

110. The method as defined in claim 96 further comprising generating an object that comprises the machine-readable graphical code.

111. The method as defined in claim 110 wherein the object further comprises object properties.

112. The method as defined in claim 110 further comprising providing a user interface for editing the object.

113. The method as defined in claim 96 further comprising searching for a string that matches a search pattern to identify the item.

114. The method as defined in claim 96 wherein the machine-readable graphical code is generated through use of a template.

115. The method as defined in claim 113 wherein the search pattern is associated with a template and the machine-readable graphical code is generated through the use of the template.

116. A method for enhancing a web page with machine-readable graphical codes, the method comprising:
obtaining a web page;
identifying a hyperlink in the web page;
generating a machine-readable graphical code corresponding to the hyperlink; and
inserting the machine-readable graphical code into the web page.

117. The method as defined in claim 116 wherein the web page comprises a plurality of hyperlinks and wherein the method further comprises generating a plurality of machine-readable graphical codes.

118. The method as defined in claim 116 further comprising saving an enhanced web page.

119. The method as defined in claim 116 further comprising obtaining an original URL from a web browser.

120. The method as defined in claim 118 further comprising sending a new URL to a web browser.

121. The method as defined in claim 116 wherein the machine-readable graphical code is inserted into the web page so that when printed the web page includes the machine-readable graphical code adjacent to the hyperlink.

122. The method as defined in claim 116 further comprising sending a copy-to-clipboard message to a web browser.

123. The method as defined in claim 116 wherein the machine-readable graphical code is generated through use of a template.

124. The method as defined in claim 122 further comprising sending a select-all message to the web browser.
